(19) United States
(12) Patent Application Publication
(10) Pub. No.: US 2024/0070639 A1
(43) Pub. Date: Feb. 29, 2024

(54) UNMANNED PAYMENT METHOD USING MOBILE ROBOT AND UNMANNED PAYMENT SYSTEM USING SAME

(71) Applicant: XYZ Inc., Seoul (KR)

(72) Inventor: Sung Jae HWANG, Seoul (KR)

(73) Assignee: XYZ Inc., Seoul (KR)

(21) Appl. No.: 18/504,397

(22) Filed: Nov. 8, 2023

Related U.S. Application Data
(63) Continuation of application No. PCT/KR2021/018419, filed on Dec. 7, 2021.

(30) Foreign Application Priority Data
Sep. 24, 2021 (KR) 10-2021-0126733

(51) Int. Cl. G06Q 20/20; G06Q 20/32; G06V 20/52

(52) U.S. Cl. CPC G06Q 20/208; G06Q 20/322; G06V 20/52

(57) ABSTRACT

Disclosed herein are an unmanned payment method and system using a mobile robot in a store. The unmanned payment method includes: acquiring an image through a camera sensor installed above the plate of a mobile robot; recognizing a product, selected and taken by a customer, using the acquired image; identifying a table related to the customer; and calculating a payment amount for the product for the identified table.

### CROSS-REFERENCE TO RELATED APPLICATIONS

This application is a continuation of International Application No. PCT/KR2021/018419 filed on Dec. 7, 2021, which claims priority to Korean Patent Application No. 10-2021-0126733 filed on Sep. 24, 2021, the entire contents of which are herein incorporated by reference.

### TECHNICAL FIELD

The present invention relates to an unmanned payment method using a mobile robot and an unmanned payment system using the same. More particularly, the present invention relates to a method and system for implementing unmanned payment in an environment, in which tables are present, by using an indoor mobile robot including various sensors.

### BACKGROUND ART

In general, when a user selects a product and then approaches a checkout counter in a space such as a mart, a supermarket, a shopping center, a department store, a convenience store, or a restaurant where products can be purchased, an employee directly scans the barcode of the product with a barcode reader, and processes payment for the product using a payment means, such as a credit card, cash, or the like, provided by the user.

Recently, due to the spread of non-face-to-face culture and noncontact culture attributable to the coronavirus, there is a growing tendency to reduce the costs of contact with people. An increase in minimum hourly wage increases a labor cost burden. The working population decreases due to aging. The number of cases where simple labor tasks are being replaced by robots is gradually increasing.

Recently, with the development of robot technology, serving robots that bring food to customers' tables instead of people are being used in restaurants. Due to the unmanned technology using a serving robot, there are provided the advantages of lowering human fatigue and improving the quality of service in such a manner that serving robots perform repetitive tasks instead of people. However, the current mobile robots are focused on only one function of moving food to tables, and processes such as a payment process are performed through a separate device or person.

Therefore, there is a need for an unmanned payment method and system capable of supporting more diverse and simple types of payment that can deal with not only a food transfer function but also an unmanned payment function through product recognition by using a mobile robot.

### RELATED ART DOCUMENT

7Patent document: Korean Patent No. 10-2146058

### DISCLOSURE

### Technical Problem

An object of the present invention is to provide an unmanned payment method and system using a mobile robot that can automatically recognize a product selected and taken by a customer using a camera sensor, a weight sensor, a proximity sensor, and/or the like and process payment for the corresponding product.

An object of the present invention is to provide an unmanned payment method and system using a mobile robot that can accurately determine a table having taken a product by considering the distance between the mobile robot and each table and the moving direction of the product in an integrated manner.

An object of the present invention is to provide an automated and convenient unmanned payment method and system that can calculate a payment amount for a product sold through a mobile robot to a customer by using the payment means information and table information of the customer.

An object of the present invention is to provide an unmanned payment method and system that can automatically process payment for a product for sale while reducing human labor and moving the product.

The technical problems of the present invention are not limited to the above-described technical problems, and other technical problems that have not been described above will be clearly understood by those of ordinary skill in the art from the following description.

### Technical Solution

According to an aspect of the present invention, there is provided an unmanned payment method using a mobile robot in a store, the unmanned payment method including: acquiring an image through a camera sensor installed above the plate of a mobile robot; recognizing a product, selected and taken by a customer, using the acquired image; identifying a table related to the customer; and calculating a payment amount for the product for the identified table.

The unmanned payment method may further include detecting a change in the weight of the plate of the mobile robot, and recognizing the product may include recognizing the product, taken by the customer, based on the change in the weight of the plate and the result of the analysis of the image acquired via the camera sensor.

Identifying the table related to the customer may include identifying a table closest to the mobile robot when the customer has taken the product.

The unmanned payment method may further include: recognizing the moving direction of the product taken by the customer; and identifying a table corresponding to the moving direction of the product.

Identifying the table corresponding to the moving direction of the product may not be performed when the distance between the mobile robot and the closest table is within a predetermined reference.

The unmanned payment method may further include generating an alarm when the table corresponding to the moving direction of the product is different from the closest table.

The moving direction of the product may be determined based on measured values of a plurality of proximity sensors disposed on the periphery of the plate of the mobile robot.

The moving direction of the product may be determined based on the moving direction of a hand that picks up and takes the product.

The unmanned payment method may further include: registering a payment means of the customer; identifying a table at which the customer is seated; and requesting payment for the payment amount, calculated for the table at which the customer is seated, using the registered payment means of the customer.

According to another aspect of the present invention, there is provided an unmanned payment system using a mobile robot in a store, the unmanned payment system including: at least one camera sensor installed above the plate of a mobile robot; an image acquirer configured to acquire an image via the camera sensor; a recognition processor configured to recognize a product, selected and taken by a customer, using the acquired image, and to identify a table related to the customer; and a payment processor configured to calculate a payment amount for the product for the identified table.

The unmanned payment system may further include a weight sensor configured to detect a change in the weight of the plate of the mobile robot, and the recognition processor may be further configured to recognize the product, taken by the customer, based on the change in the weight of the plate and the result of the analysis of the image acquired via the camera sensor.

The recognition processor may be further configured to identify a table closest to the mobile robot when the customer has taken the product.

The recognition processor may be further configured to recognize the moving direction of the product taken by the customer and to identify a table corresponding to the moving direction of the product.

The recognition processor may be configured not to perform identifying the table corresponding to the moving direction of the product when the distance between the mobile robot and the closest table is within a predetermined reference.

The recognition processor may be further configured to generate an alarm when the table corresponding to the moving direction of the product is different from the closest table.

The moving direction of the product may be determined based on measured values of a plurality of proximity sensors disposed on the periphery of the plate of the mobile robot.

The moving direction of the product may be determined based on the moving direction of a hand that picks up and takes the product.

The payment processor may be further configured to register a payment means of the customer and to request payment for the payment amount, calculated for a table at which the customer is seated, to be made via the registered payment means of the customer, and the recognition processor may be further configured to identify the table at which the customer is seated.

### Advantageous Effects

According to the present invention, there may be provided the unmanned payment method and system using a mobile robot that can automatically recognize a product selected and taken by a customer using the camera sensor, the weight sensor, the proximity sensor, and/or the like and process payment for the corresponding product.

According to the present invention, there may be provided the unmanned payment method and system using a mobile robot that can accurately determine a table having taken a product by considering the distance between the mobile robot and each table and the moving direction of the product in an integrated manner.

According to the present invention, there may be provided the automated and convenient unmanned payment method and system that can calculate a payment amount for a product sold through the mobile robot to a customer by using the payment means information and table information of the customer.

According to the present invention, there may be provided the unmanned payment method and system that can automatically process payment for a product for sale while reducing human labor and moving the product.

The effects of the present invention are not limited to the above-described effects, and other effects that have not been described above will be clearly understood by those of ordinary skill in the art from the following description.

### DESCRIPTION OF DRAWINGS

The above and other objects, features and advantages of the present invention will be more clearly understood from the following detailed description taken in conjunction with the accompanying drawings, in which:

FIG. 1 is a block diagram illustrating the configuration of an unmanned payment system using a mobile robot according to an embodiment of the present invention;

FIGS. 2a and 2b are exemplary views illustrating the configurations of a mobile robot and a camera sensor according to embodiments of the present invention;

FIG. 3 is an exemplary diagram illustrating a method of recognizing a product selected and taken by a customer using a mobile robot and also recognizing a table at which a purchasing customer is located according to an embodiment of the present invention;

FIG. 4 is an exemplary diagram illustrating a method of recognizing the moving direction of a product and also recognizing a table at which a purchasing customer is located by using a mobile robot according to an embodiment of the present invention;

FIG. 5 is an exemplary diagram illustrating an automatic payment processing method for a customer, whose payment means has been registered, using a mobile robot according to an embodiment of the present invention; and

FIG. 6 is a flowchart illustrating an unmanned payment method using a mobile robot according to an embodiment of the present invention.

### DETAILED DESCRIPTION

Embodiments of the present invention will be described in detail below with reference to the accompanying drawings so that those of ordinary skill in the art to which the present invention pertains can easily implement the present invention. However, the present invention may be embodied in various different forms and is not limited to the embodiments described herein. Furthermore, in order to clearly illustrate the embodiments of the present invention in the drawings, portions irrelevant to the illustration are omitted.

The terms used herein are intended to describe only specific embodiments and are not intended to limit the present invention. In this specification, a singular form also includes a plural form unless the context clearly dictates otherwise.

In this specification, the terms such as “comprise,” “have,” or “include” are intended to designate features, numbers, steps, operations, components, parts, or combinations thereof described in the specification as being present. It can be understood that this does not preclude in advance the possibility of the presence or addition of one or more other features, numbers, steps, operations, components, parts, or combinations thereof.

Furthermore, the components appearing in the embodiments of the present invention are shown independently of each other to represent distinct characteristic functions, and this does not mean that each of the components is configured in the form of a separate piece of hardware or a single software unit. In other words, individual components are listed as respective components for ease of description. At least two of the individual components may be combined into a single component, or a single component may be divided into a plurality of components and perform a function. An embodiment in which some components are combined together and an embodiment in which a single component is divided into a plurality of components are also included in the scope of the present invention as long as they do not depart from the gist of the present invention.

Moreover, the following embodiments are provided to more clearly describe the present invention to those of ordinary skill in the art, and the shapes and sizes of the components in the drawings may be exaggerated for clearer illustration.

The embodiments of the present invention will be described below with reference to the accompanying drawings.

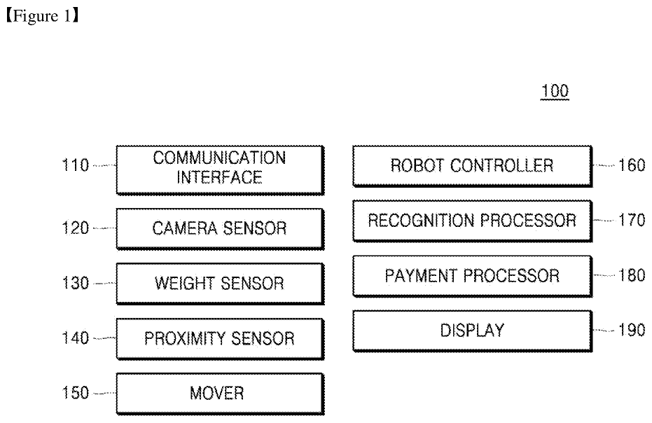

FIG. 1 is a block diagram illustrating the configuration of an unmanned payment system 100 using a mobile robot according to an embodiment of the present invention.

Referring to FIG. 1, the unmanned payment system 100 using a mobile robot may include a communication interface 110, a camera sensor 120, a weight sensor 130, a proximity sensor 140, a mover 150, a robot controller 160, a recognition processor 170, a payment processor 180, and a display 190. Some components may be omitted or additional components may be added as needed.

The communication interface 110, the camera sensor 120, the weight sensor 130, the proximity sensor 140, the mover 150, the robot controller 160, the recognition processor 170, the payment processor 180, and the display 190 may all be included in the mobile robot. Furthermore, at least one of the recognition processor 170 and the payment processor 180 may be included in a separate device or a server. In this case, the mobile robot may communicate with at least one of the recognition processor 170 and the payment processor 180 via the communication interface 110.

The communication interface 110 may be configured to receive necessary information from an external server or an external device or transmit acquired information to an external server or an external device over a network. In this case, the network may be a network connected via a wired or wireless connection. Furthermore, the connection network may be a network over which an external device and the mobile robot are directly connected, or may be a private network which is generated by a repeater. When the network is a wireless communication network, it may include a network for cellular communication or short-range communication. For example, the cellular communication may include at least one of Long-Term Evolution (LTE), LTE Advanced (LTE-A), 5th Generation (5G), Code Division Multiple Access (CDMA), Wideband CDMA (WCDMA), Universal Mobile Telecommunications System (UMTS), Wireless Broadband (WiBro), and Global System for Mobile Communications (GSM). Furthermore, the short-range communication may include at least one of Wireless Fidelity (Wi-Fi), Bluetooth, Zigbee, and Near Field Communication (NFC). However, the communication method is not limited thereto, and will include wireless communication technology to be developed in the future.

The camera sensor 120 may include a plurality of camera sensors installed on the plate of the mobile robot, and photographs an image requiring analysis and transmits the photographed image to the recognition processor 170 so that the recognition processor 170 can perform image analysis. For example, the camera sensor 120 may be arranged to photograph a product displayed on the plate of the mobile robot and to photograph the top of the plate from a location above the plate in order to recognize a product selected and taken by a customer in real time.

The weight sensor 130 may be configured to detect a change in the weight of the plate of the mobile robot, and may be configured to detect a change in weight that occurs when a product is placed on the plate or when a user or customer selects and takes a product on the plate.

The proximity sensor 140 may serve to recognize the movement direction of a product when a user or customer picks up and takes a product, and may be disposed, e.g., at a plurality of locations on the periphery of the plate of the mobile robot. For example, the proximity sensor 140 may include various types of sensors, such as IR (infrared) sensors, camera sensors, ultrasonic sensors, laser sensors, and optical sensors. The proximity sensor 140 may include a variety of sensors capable of recognizing a direction in which a product is moved after the product has been held using a user's hand.

The mover 150 is a component that enables the movement of the mobile robot. For example, the mover 150 may be fabricated in the form of a plurality of wheels, may be configured in various forms that enable movement, and may move autonomously under the movement control of the robot controller 160.

The robot controller 160 may be configured to control the movement of the mobile robot through the mover 150, may include a central processing unit (CPU), an application processor (AP), and/or the like, and may be configured to perform various processes related to the control of the camera sensor 120, the weight sensor 30, and the proximity sensor 140, the control of the display 190, various types of image processing, and/or recognition operations.

The recognition processor 170 may be configured to recognize a product, selected and taken by a customer, using an image acquired through the camera sensor 120 and to identify a table related to the customer. The recognition processor 170 may include a central processing unit (CPU), an application processor (AP), and/or the like, and may be installed in the mobile robot or be configured in a separate device or server to be connected via the communication interface 110 of the mobile robot. Furthermore, a program or program modules included in the recognition processor 170 may be configured in the form of an operating system, an application program, or a program, and may be physically stored in various types of widely used storage devices. Such a program or program modules may include various forms for performing one or more routines, subroutines, programs, objects, components, instructions, data structures, and specific tasks or executing specific data types, but are not limited thereto.

Furthermore, the recognition processor 170 may be configured to recognize a product, taken by a customer, based on a change value in the weight of the plate obtained through the weight sensor 130 and an image analysis result obtained through the camera sensor 120.

Furthermore, the recognition processor 170 may be configured to identify a table closest to the mobile robot at the time a customer takes a product, and may be configured to recognize the moving direction of a product utilizing the camera sensor 120 and the proximity sensor 140 and to identify a table corresponding to the moving direction of the product. In this case, in order to measure the distance to the table, the geographic map information of a corresponding space such as a diner or a restaurant, table location information or environment information in the corresponding space is stored in advance in the server, the location of the mobile robot is recognized in real time using an ultrasonic sensor, a lidar sensor, and/or a laser sensor, and the relative location of the table is determined in real time, so that the closest table may be identified by measuring the distance to each table. Furthermore, the distance to the table may be directly measured using an ultrasonic sensor or a lidar sensor. Furthermore, in order to identify each table, the location of the table may be designated and stored in advance, the number of the table may be identified using the camera sensor 120 of the mobile robot or a camera sensor or lidar sensor separately installed in a corresponding space, and a reflector or code marker may be attached to the ceiling of the space or a specific location for the purpose of accurate identification. In addition, the recognition processor 170 may be configured to identify the closest table by recognizing the location of the mobile robot and the distance between the mobile robot and the table through image recognition via a plurality of cameras configured to photograph the mobile robot and the table on the ceiling of the corresponding space.

Furthermore, in the case where a customer at the closest table takes a product when the mobile robot is adjacent to the specific table, it is not a problem if a payment amount is calculated for the corresponding table. However, if another customer at a distant table moves and takes the product, a payment request for the product may be processed incorrectly. Accordingly, a table for which a payment request will be processed may be correctly identified by recognizing the moving direction of a product using the camera sensor 120 and the proximity sensor 140 mounted on the mobile robot and then identifying a table corresponding to the moving direction.

Furthermore, when the distance between the mobile robot and the closest table is within a predetermined reference, i.e., when the mobile robot is considerably close to a specific table, it is rare for a customer at another table to come and take a product. Accordingly, in this case, the recognition processor 170 may make a payment request for the corresponding product to the corresponding table by identifying only the closest table without performing the step of identifying a table corresponding to the moving direction of the product.

Furthermore, the recognition processor 170 may be configured to issue an alarm when a table corresponding to the moving direction of a product and the closest table are different from each other. Accordingly, when a customer at a distant table picks up and takes a product, an alarm may be provided to the customer in the form of sound or display, and a payment request for the product may be prevented from being processed erroneously for the closest table.

The payment processor 180 may be configured to calculate a payment amount for a product for a table identified as being related to a customer who has taken the product. Payment amounts for a plurality of products taken at a plurality of time points may be summed and applied for a corresponding table, and payment processing may be performed using the calculated summed amount upon final payment. The payment processor 180 may include a central processing unit (CPU), an application processor (AP), and the like, and may be installed in the mobile robot or be configured in a separate device or server to be connected via the communication interface 110 of the mobile robot. Furthermore, a program or program modules included in the recognition processor 170 may be configured in the form of an operating system, an application program, or a program, and may be physically stored in various types of widely used storage devices. Such a program or program modules may include various forms for performing one or more routines, subroutines, programs, objects, components, instructions, data structures, and specific tasks or executing specific data types, but are not limited thereto.

Furthermore, the payment processor 180 may be configured to be connected to a point of sales (POS) terminal in charge of the payment processing of a corresponding store and to deliver the payment information of each table, or may be configured to be directly connected to a payment server and to perform card payment, mobile payment, simple payment, and/or the like.

Furthermore, when a customer enters a corresponding space, a payment means may be registered by allowing a payment means, such as a specific credit card or a simple payment means, to be recognized at the entrance of the space. The recognition processor 170 may identify a table at which the customer is seated by tracking the movement of the customer through image analysis or the like. In this case, the payment processor 180 may request payment to be made via the registered payment means of the customer for a payment amount calculated for the table at which the customer is seated.

The display 190 may be configured to display information related to a product for sale and payment. For example, the display 190 may display the price of a product disposed on the plate of the mobile robot, and may display the payment information of the product, e.g., table identification information or customer identification information for which a payment request is to be performed, when the customer takes the product. Furthermore, when the table corresponding to the moving direction of the product and the closest table are different from each other, the display of an alarm may be provided through the display 190.

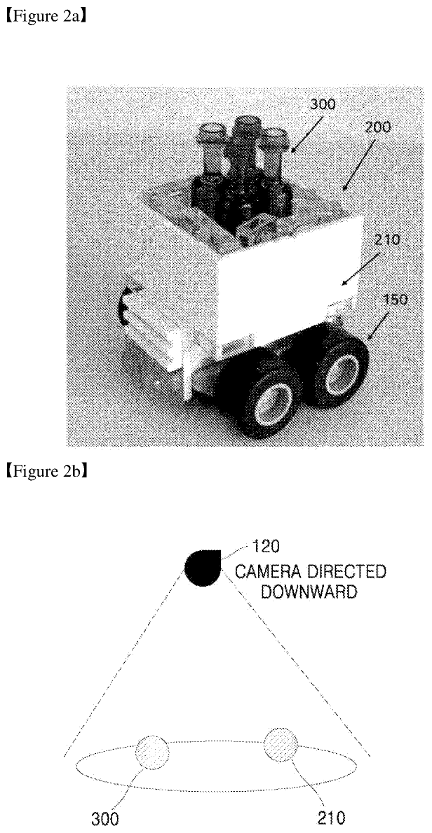

FIGS. 2a and 2b are exemplary views illustrating the configurations of a mobile robot and a camera sensor according to embodiments of the present invention.

Referring to the example of FIG. 2a, the mobile robot 200 may move autonomously via the mover 150 such as wheels, and may include a plate 210 configured in various forms to allow a product for sale to be placed thereon. A plurality of products 300 may be disposed on the plate, and a customer may select and take a desired product.

FIG. 2b is a diagram illustrating an example of the arrangement of the camera sensor 120. For example, the camera sensor 120 may recognize the plurality of products 300 disposed on the plate 210 of the mobile robot 200 in real time. In order to accurately recognize a product taken by the customer or the moving direction of the product, the camera sensor 120 may be disposed on the plate 210 of the mobile robot 200 and perform downward photographing.

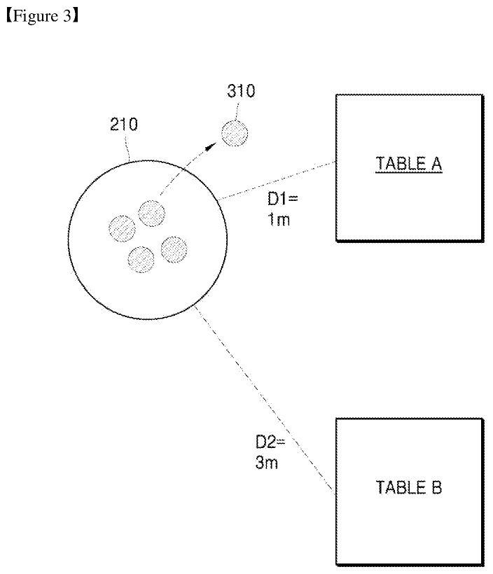

FIG. 3 is an exemplary diagram illustrating a method of recognizing a product selected and taken by a customer using a mobile robot and also recognizing a table at which a purchasing customer is located according to an embodiment of the present invention.

Referring to FIG. 3, when a customer selects and takes a specific product 310 from among products disposed on the plate 210 of the mobile robot 200, a table closest to the mobile robot 200 at that time may be identified.

In the process of recognizing the specific product 310 taken by the customer, for example, the specific product 310 may be recognized through the analysis of an image acquired through the camera sensor 120 or the type of corresponding product may be recognized by detecting a change in weight via the weight sensor 130 installed on the plate 210, and the product taken by the customer may be recognized more accurately by utilizing both the camera sensor 120 and the weight sensor 130.

In addition, the closest table may be recognized by measuring the distance between the mobile robot 200 and each table at a corresponding time point after the specific product 310 is recognized. For example, when there are three drinks A of 80 g and two drinks B of 200 g on the plate, they have a total weight of 640 g. When the total weight becomes 560 g at a specific time t1, it may be recognized that beverage A of 80 g has been taken. In this case, at time t1, the distance (D1=1 m) between the mobile robot 200 and table A and the distance (D2=3 m) between the mobile robot 200 and table B may be recognized, and a payment amount for beverage A corresponding to table A at the closest distance (D1=1 m) may be calculated and applied.

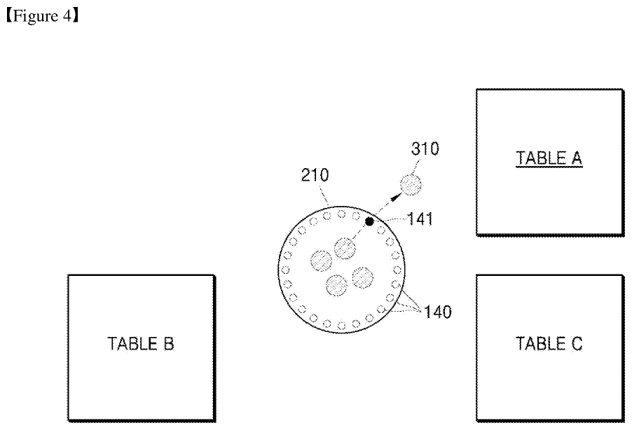

FIG. 4 is an exemplary diagram illustrating a method of recognizing the moving direction of a product and also recognizing a table at which a purchasing customer is located by using a mobile robot according to an embodiment of the present invention.

Referring to FIG. 4, when there is a plurality of proximity sensors 140 disposed on the periphery of the plate 210 of the mobile robot 200 and a product 310 selected by a specific customer is taken in the direction in which a specific proximity sensor 141 is located, the direction in which the product disposed on the plate 210 is moved and taken may be determined by recognizing the moving direction of the product based on a measured value of the proximity sensor 141.

Even in the case where the distance between the mobile robot 200 and table A and the distance between the mobile robot 200 and table C are similar to each other or the distance between the mobile robot 200 and table A is longer than the distance between the mobile robot 200 and table C, when a table corresponding to the moving direction of the product is determined to be table A, it may be determined that a customer at table A has taken the corresponding product, and a payment amount for the product 310 for table A may be calculated.

In addition, it is determined that the mobile robot 200 is closer to table C than to table A. If it is determined that a table corresponding to the moving direction of the product is table A, it is highly likely that the product has not been actually taken by a customer at the closest table, and thus an alarm may be generated. In this case, the customer may place the product on the plate 210 again, or may perform a separate procedure for calculating a payment amount for his/her table A.

Furthermore, in order to determine the moving direction of the product, it may be possible to use not only the measured values of the plurality of proximity sensors 141 but also the image analysis result of the camera sensor 120 disposed on the plate 121. For example, the moving direction of the product may be determined more accurately by recognizing the hand of a customer that picks up and takes a product and then tracking the moving direction of the hand.

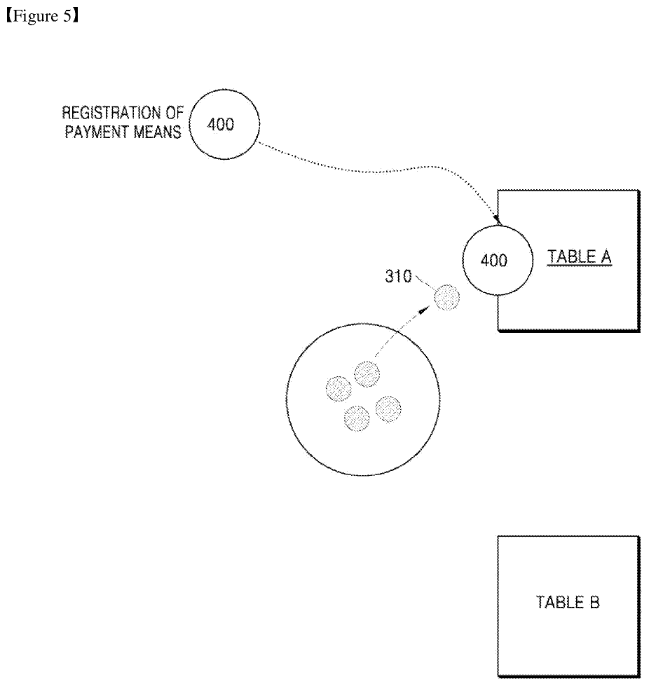

FIG. 5 is an exemplary diagram illustrating an automatic payment processing method for a customer, whose payment means has been registered, using a mobile robot according to an embodiment of the present invention.

When a customer 400 enters a corresponding space such as a restaurant or store, a desired payment means may be registered in advance by allowing a payment means, such as a credit card, an app payment means, or a simple payment means, to be recognized at the entrance of the space. In this case, a table at which a customer is seated, e.g., table A, may be identified by tracking the movement of the customer via the recognition processor 170 or a separate image sensor in the store. When the customer 400 has selected and taken the product 310, a payment amount may be calculated for table A at which the customer is seated via the payment processor 180, and payment may be requested to be made via the registered payment means of the customer 400.

In this case, payment for the table at which the customer is located may be automatically made via the payment means registered in advance by the customer, and thus a separate calculation procedure is not required when the customer leaves the store.

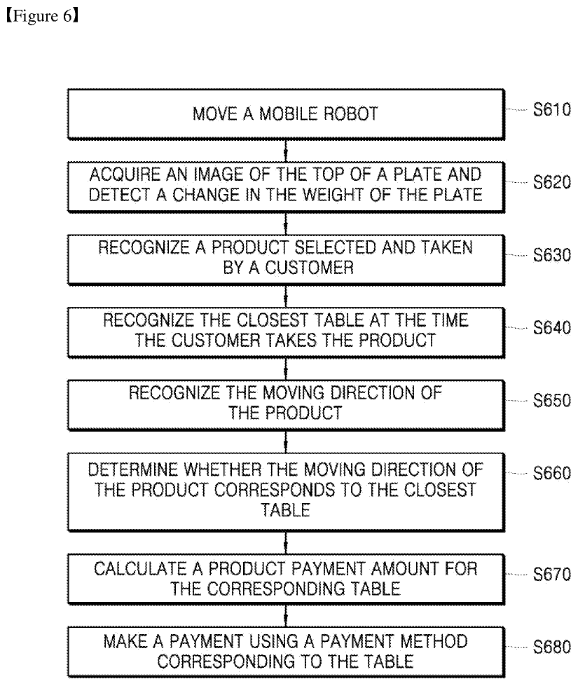

FIG. 6 is a flowchart illustrating an unmanned payment method using a mobile robot according to an embodiment of the present invention.

First, the mobile robot 200 may freely move within a corresponding space, such as a restaurant or store, through autonomous driving, and, for example, when a specific table or a specific customer's call is recognized, may move to the corresponding location at step S610.

The mobile robot 200 acquires an image of the top of the plate and detects a change in the weight of the plate at step S620, and whether a customer has taken a product and the type of product may be recognized based on the results of the above operations at step S630.

When it is recognized that the customer has taken the product, the closest table may be recognized by measuring the distance between the mobile robot 200 and each table at the time the customer has taken the product at step S640.

Furthermore, the moving direction in which the customer has taken the product may be recognized using the proximity sensor 140 and the camera sensor 120 at step S650.

In this case, it may be determined whether the moving direction of the product and the closest table correspond to each other at step S660.

When a table, corresponding to the moving direction in which the customer has taken the product, and the closest table are the same, it may be determined that a customer at the closest table has taken the product and a product payment amount may be calculated for the closest table at step S670.

When the corresponding table or the customer seated at the corresponding table has registered a payment means or method in advance, automatic payment may be performed using the payment means corresponding to the corresponding table at step S680.

The various embodiments described herein may be implemented by hardware, middleware, microcode, software, and/or combinations thereof. For example, the various embodiments may be implemented in one or more application specific semiconductors (ASICs), digital signal processors (DSPs), digital signal processing devices (DSPDs), programmable logic devices (PLDs), field programmable gate arrays (FPGAs), processors, controllers, microcontrollers, microprocessors, other electronic units designed to perform the functions presented herein, and/or one or more combinations thereof.

Furthermore, for example, the various embodiments may be stored or encoded in a computer-readable medium containing instructions. The instructions stored or encoded in a computer-readable medium may cause a programmable processor or another processor to perform a method, e.g., when the instructions are executed. The computer-readable medium includes both computer storage media and communication media including any media that facilitate the transfer of a computer program from one place to another. The storage medium may be any available medium that can be accessed by a computer. For example, the computer-readable medium may include random access memory (RAM), read-only memory (ROM), electrically erasable programmable read-only memory (EEPROM), compact disk read-only memory (CD-ROM), other optical disk storage media, magnetic disk storage media, other magnetic storage devices, and any other media that can be used to carry or store desired program code in the form of instructions or data structures accessible by a computer.

The hardware, the software, the firmware, etc. may be implemented in the same device or separate devices in order to support the various operations and functions described herein. Additionally, components, units, modules, components, etc. described as “units” herein may be implemented together, or may be implemented individually as interoperable logic devices. The depictions of the different features of modules, units, etc. are intended to highlight different functional embodiments, and do not necessarily imply that these must be embodied by separate hardware or software components. Rather, the functions associated with one or more modules or units may be performed by separate hardware or software components or may be integrated into the same hardware or software component.

Although operations are shown in a particular order in the drawings, it should be understood that the operations may be performed in the shown particular order or in another sequential order or all the shown operations may not be necessarily performed in order to achieve a desired result. In some circumstances, multitasking and parallel processing may be advantageous. Moreover, the division of various components in the above-described embodiments should not be construed as being required in all the embodiments. It should be understood that described components may be integrated into a single software product or may be packaged into multiple software products.

Although the present invention has been described with reference to the embodiment shown in the drawings, this is merely illustrative, and it will be understood by those of ordinary skill in the art that various modifications and equivalent embodiments may be possible therefrom. Therefore, the true technical protection range of the present invention should be determined based on the technical spirit of the appended claims.

What is claimed is:

1. An unmanned payment method using a mobile robot in a store, the unmanned payment method comprising:
acquiring an image through a camera sensor installed above a plate of a mobile robot;
recognizing a product, selected and taken by a customer, using the acquired image;
identifying a table related to the customer; and
calculating a payment amount for the product for the identified table.

2. The unmanned payment method of claim 1, further comprising detecting a change in weight of the plate of the mobile robot,
wherein recognizing the product comprises recognizing the product, taken by the customer, based on the change in the weight of the plate and a result of an analysis of the image acquired via the camera sensor.

3. The unmanned payment method of claim 1, wherein identifying the table related to the customer comprises identifying a table closest to the mobile robot when the customer has taken the product.

4. The unmanned payment method of claim 3, further comprising:
recognizing a moving direction of the product taken by the customer; and
identifying a table corresponding to the moving direction of the product.

5. The unmanned payment method of claim 4, wherein identifying the table corresponding to the moving direction of the product is not performed when a distance between the mobile robot and the closest table is within a predetermined reference.

6. The unmanned payment method of claim 4, further comprising generating an alarm when the table corresponding to the moving direction of the product is different from the closest table.

7. The unmanned payment method of claim 4, wherein the moving direction of the product is determined based on measured values of a plurality of proximity sensors disposed on a periphery of the plate of the mobile robot.

8. The unmanned payment method of claim 4, wherein the moving direction of the product is determined based on a moving direction of a hand that picks up and takes the product.

9. The unmanned payment method of claim 1, further comprising:
registering a payment means of the customer;
identifying a table at which the customer is seated; and
requesting payment for the payment amount, calculated for the table at which the customer is seated, using the registered payment means of the customer.

10. An unmanned payment system using a mobile robot in a store, the unmanned payment system comprising:
at least one camera sensor installed above a plate of a mobile robot;
an image acquirer configured to acquire an image via the camera sensor;
a recognition processor configured to recognize a product, selected and taken by a customer, using the acquired image, and to identify a table related to the customer; and
a payment processor configured to calculate a payment amount for the product for the identified table.

11. The unmanned payment system of claim 10, further comprising a weight sensor configured to detect a change in weight of the plate of the mobile robot,
wherein the recognition processor is further configured to recognize the product, taken by the customer, based on the change in the weight of the plate and a result of an analysis of the image acquired via the camera sensor.

12. The unmanned payment system of claim 10, wherein the recognition processor is further configured to identify a table closest to the mobile robot when the customer has taken the product.

13. The unmanned payment system of claim 12, wherein the recognition processor is further configured to recognize a moving direction of the product taken by the customer and to identify a table corresponding to the moving direction of the product.

14. The unmanned payment system of claim 13, wherein the recognition processor is configured not to perform identifying the table corresponding to the moving direction of the product when a distance between the mobile robot and the closest table is within a predetermined reference.

15. The unmanned payment system of claim 13, wherein the recognition processor is further configured to generate an alarm when the table corresponding to the moving direction of the product is different from the closest table.

16. The unmanned payment system of claim 13, wherein the moving direction of the product is determined based on measured values of a plurality of proximity sensors disposed on a periphery of the plate of the mobile robot.

17. The unmanned payment system of claim 13, wherein the moving direction of the product is determined based on a moving direction of a hand that picks up and takes the product.

18. The unmanned payment system of claim 10, wherein:
the payment processor is further configured to register a payment means of the customer and to request payment for the payment amount, calculated for a table at which the customer is seated, to be made via the registered payment means of the customer; and
the recognition processor is further configured to identify the table at which the customer is seated.
